(19) United States
(12) Patent Application Publication
(10) Pub. No.: US 2026/0289234 A1
(43) Pub. Date: Sep. 24, 2026

(54) RESERVOIR COMPUTING DEVICE, METHOD FOR PROCESSING RESERVOIR COMPUTING DEVICE AND METHOD FOR MANUFACTURING RESERVOIR COMPUTING DEVICE

(71) Applicant: TDK Corporation, Tokyo (JP)

(72) Inventor: Yukio TERASAKI, Tokyo (JP)

(73) Assignee: TDK Corporation, Tokyo (JP)

(21) Appl. No.: 19/551,819

(22) Filed: Feb. 27, 2026

Related U.S. Application Data
(63) Continuation-in-part of application No. 19/085,417, filed on Mar. 20, 2025.

(51) Int. Cl. G06N 3/044

(52) U.S. Cl. CPC G06N 3/044

(57) ABSTRACT

A reservoir computing device includes an input unit, a physical reservoir, an evaluation selection unit, and an output unit. The input unit includes a conversion unit that converts an external signal into a converted signal. The evaluation selection unit is configured to obtain a first dependency between the input signal input to the physical reservoir and the output signal output from each of the plurality of nodes of the physical reservoir, and to be able to select one or more selected nodes that exhibit a dependency satisfying a predetermined criterion from among the first dependencies. The output unit is configured to be able to apply a weight to an extracted signal from the selected node among the output signals.

### BACKGROUND OF THE INVENTION

### Field of the Invention

The present disclosure relates to a reservoir computing device, a method for processing the reservoir computing device, and a method for manufacturing the reservoir computing device.

### Description of Related Art

Reservoir computing is a type of machine learning in the field of information engineering, and is a method of performing information processing using nonlinear dynamical systems. Reservoir computing stores information in a dynamical system referred to as a reservoir, and combines the information with input data to generate outputs. The dynamical system in the reservoir is expressed by a network for nodes and elements, and shows a nonlinear behavior.

The concept of reservoir computing was proposed by Jaeger in the early 2000s. The dynamical system in the reservoir has a random coupling structure, and thus the reservoir stores information of input data and generates outputs based on the input data. This idea is an approach of a recurrent neural network that differs from a neural network of the related art, and has attracted attention as a new information processing method.

Reservoir computing is applied in various fields, such as voice recognition, time-series data prediction, and pattern recognition. In particular, reservoir computing exhibits high performance in processing of data that has strong time dependencies and nonlinearity. For example, in voice recognition, the waveform of a voice signal is input to a reservoir, and thus a dynamical system in the reservoir extracts the features of vocal sound and outputs voice recognition results. In time-series data prediction, past data is input to the reservoir, and thus the dynamical system in the reservoir predicts future states.

Reservoir computing is unlikely to be affected by the dimensions of data or the number of samples, and is highly versatile. This is because the reservoir can recognize complex data patterns by a nonlinear behavior of the dynamical system in the reservoir. In addition, reservoir computing is also suitable for real-time processing, and is effective in applications that require high-speed information processing. In recurrent neural network (RNN) technology such as long short term memory (LSTM), a computing cost for learning was an issue. On the other hand, in reservoir computing, coupling weights in a reservoir layer, which is responsible for nonlinear conversion, may be fixed values set randomly, and the weights that are optimized through learning are only weights in an output layer configured by linear combination. Thus, among recurrent neural networks (RNNs), reservoir computing has a low computing cost for learning. Reservoir computing is also attracting attention because it is not limited to batch learning, and also allows online learning using inference results.

Research is underway to perform reservoir computing using physical elements (for example, Patent Document 1 and Patent Document 2). Instead of performing reservoir computing using software of the related art, processing corresponding to the computing is performed using physical phenomena such as electricity, magnetism, and dynamics of polymers. This is referred to as a physical reservoir or physical reservoir computing. In order to implement reservoir computing using physical phenomena, it is necessary to construct a dynamical system using industrially manufactured physical elements. For example, physical reservoirs using optical elements or electrical elements are being considered.

As an example, a physical reservoir may use optical elements to perform information processing by using the propagation and nonlinearity of light. In a physical reservoir using optical elements, a propagation path and intensity of light correspond to information for reservoir computing, and an output is generated by the interaction of input data within the physical reservoir. Optical elements are capable of high-speed processing and can also be used to construct large-scale networks. For example, a propagation path of light can be controlled by using optical fibers and optical waveguides.

Physical reservoirs using electrical elements perform information processing using structures and principles of electronic circuits, semiconductor elements, or electronic devices. Physical reservoirs using electrical elements store information by using a dynamic behavior and nonlinearity of electronic circuits, and an output is generated through the interaction of input data within the physical reservoir. Electrical elements are becoming smaller and less power-consuming, and are highly flexible in their implementation. For example, physical reservoirs using electrical elements can be constructed using transistors, MEMS technology, thin-film techniques, and the like.

### CITATION LIST

### Patent Documents

[Patent Document 1] PCT International Publication No. WO2021/192147
[Patent Document 2] PCT International Publication No. WO2020/208674

### SUMMARY OF THE INVENTION

Incidentally, reservoir computing as a computing model allows the number of nodes in the reservoir layer, coupling relations of nodes in the reservoir layer, activation functions, etc., to be freely set and tried, and the optimal combination can be selected. This makes it possible to use it for various tasks, and thus, reservoir computing is characterized by its high versatility. On the other hand, a physical reservoir is a structure and is generally difficult to modify after being manufactured. For example, to increase the amount of input data to the physical reservoir, it is necessary to increase the amount of wiring and number of input/output terminals for input data. Increasing the amount of wiring and number of input/output terminals increases the difficulty of manufacturing the physical reservoir, which leads to increased costs.

In addition, a physical reservoir is a structure, and it is not easy to change the structure or interface of a physical reservoir corresponding to a sensor to be used. For example, it is not possible to directly connect an inertial sensor and the like that has multidimensional information such as six axes to a physical reservoir that assumes a one-dimensional input signal. Even when the input signal is made into a one-dimensional form using a wired OR, it is difficult to achieve the performance as a reservoir computing device. This is because the performance (nonlinear performance and memory performance) of the physical reservoir is determined by the design, such as the structure and physical principle of the device.

As described above, a physical reservoir has more restrictions on degrees of freedom and versatility than reservoir computing performed in software, etc.

This disclosure has been made in consideration of the above circumstances, and provides a highly versatile reservoir computing device while being based on a physical reservoir.

A reservoir computing device according to a first aspect includes an input unit, a physical reservoir, an evaluation selection unit, and an output unit. The input unit includes a conversion unit that converts an external signal into a converted signal. The physical reservoir is connected to the input unit, and includes a plurality of nodes that are configured to perform nonlinear conversion of an input signal from the input unit and each of which is able to output an output signal. The evaluation selection unit is configured to obtain a first dependency between the input signal input to the physical reservoir and the output signal output from each of the plurality of nodes of the physical reservoir, and to be able to select one or more selected nodes that exhibit a dependency satisfying a predetermined criterion from among the first dependencies. The output unit is configured to be able to apply a weight to an extracted signal from the selected node among the output signals. The conversion unit is configured to be able to convert the external signal into the converted signal so that a second dependency between the output signal and a teacher signal is higher than a second dependency between the output signal and the teacher signal when the external signal is directly input to the physical reservoir.

Here, the first dependency is the degree of dependence that indicates a correlation between the input signal and the output signal. For example, when the output signal also varies in accordance with the input signal when the input signal varies, it can be said that the degree of dependence is high. On the other hand, when the output signal varies slightly when the input signal changes, it can be said that the degree of dependence is low. The correlation between the input signal and the output signal may be either a linear or nonlinear relationship.

Here, the second dependency means a linear or nonlinear relationship between the output signal and the teacher signal. When the two are linearly related, it is possible to determine the weight of the linear combination that correctly expresses this linear relationship. On the other hand, a nonlinear relationship cannot be accurately reproduced by linear combination, but even when the nonlinear relationship is emphasized, the performance of the reservoir computing can be expected to be improved by approximating it by linear combination.

The reservoir calculation device according to the above aspect is highly versatile.

### BRIEF DESCRIPTION OF THE DRAWINGS

FIG. 1 is a schematic diagram of a reservoir computing device according to a first embodiment.

FIG. 2A is a conceptual diagram of a reservoir according to the first embodiment.

FIG. 2B is a conceptual diagram of another example of the reservoir according to the first embodiment.

FIG. 3 is a diagram showing a setting process of the reservoir computing device according to the first embodiment.

FIG. 4 is a diagram showing estimation processing of the reservoir computing device according to the first embodiment.

FIG. 5 is a schematic diagram of a reservoir computing device according to a second embodiment.

FIG. 6 is a schematic diagram of a reservoir computing device according to a third embodiment.

FIG. 7 is a schematic diagram of a reservoir computing device according to a fourth embodiment.

FIG. 8 is a schematic diagram of a reservoir computing device according to a fifth embodiment.

FIG. 9 is a schematic diagram of a reservoir computing device according to a sixth embodiment.

FIG. 10 is a schematic diagram of a reservoir computing device according to a seventh embodiment.

FIG. 11 is a schematic diagram of a reservoir computing device according to an eighth embodiment.

FIG. 12 is a schematic diagram of a reservoir computing device according to a ninth embodiment.

FIG. 13 is a flowchart of an example of a manufacturing method for the reservoir computing device according to the ninth embodiment.

FIG. 14 is a flowchart of computation processing of the reservoir computing device according to the ninth embodiment.

FIG. 15 is a schematic diagram of a reservoir computing device according to a tenth embodiment.

FIG. 16 shows a linearity correlation between an output signal and a teacher signal in each of a first example, a second example, and a first comparative example.

FIG. 17 shows inference results of a reservoir computing device according to the first comparative example.

FIG. 18 shows inference results of a reservoir computing device according to the first example.

FIG. 19 shows inference results of a reservoir computing device according to the second example.

FIG. 20 is a flowchart of a selected node selection method in Example 6.

FIG. 21 shows evaluation results in Examples 4 to 6 and Comparative Example 2.

### DETAILED DESCRIPTION OF THE INVENTION

The present embodiment will be described in detail below with reference to the drawings as appropriate. The drawings used in the following description may show enlarged characteristic parts for the sake of convenience in order to facilitate the understanding of the features of the present disclosure, and a specific configuration and the like of each component may differ from the actual configuration and the like. The configurations and the like illustrated in the following description are merely examples, and the present disclosure is not limited thereto. The present disclosure can be implemented by appropriately modifying the configurations and the like within the scope of the effects of the present disclosure.

### First Embodiment

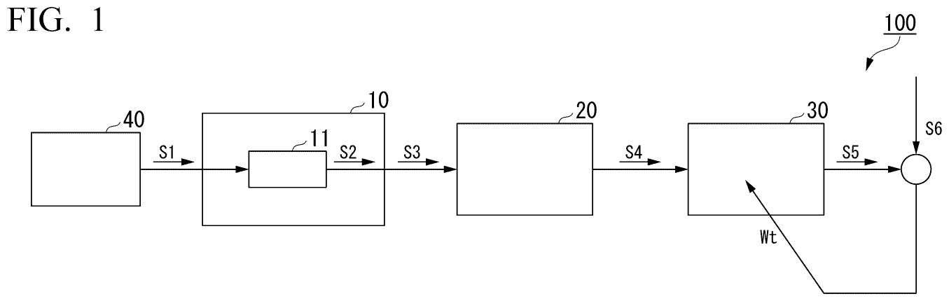

FIG. 1 is a schematic diagram of a reservoir computing device 100 according to a first embodiment. The reservoir computing device 100 includes, for example, an input unit 10, a physical reservoir 20, an output unit 30, and a sensor element 40. The reservoir computing device 100 can perform processing corresponding to reservoir computing. In addition, the reservoir computing device 100 may also be one in which the physical reservoir 20, the input unit 10, and the output unit 30 are implemented in the same package or on the same substrate. For example, the linear calculation of the output unit 30 may be implemented by an analog product-sum calculation mechanism using memristor elements, and the physical reservoir 20 may be implemented on the same silicon substrate with it.

The sensor element 40 is a detection element that receives an external signal. The sensor element 40 outputs the state of the sensing target and its changes as an external signal S1 and inputs it to the input unit 10. The sensor element 40 can be of any type as long as it can read external information as a signal. The sensor element 40 is, for example, a temperature sensor, an inertial sensor represented by an acceleration sensor or a gyro sensor, an image sensor, a microphone, a sensor related to smell or taste, or the like. The sensor element 40 may be removable from the reservoir computing device 100.

The input unit 10 is connected to the sensor element 40 and the physical reservoir 20. In this specification, connection may be either wired or wireless connection as long as signals can be transmitted. The input unit 10 is an interface for receiving information from the sensor element 40. The input unit 10 converts an external signal S1 input from the sensor element 40 into a converted signal S2. The input unit 10 may be a microcontroller unit (MCU) or a microprocessor unit (MPU) including a central processing unit (CPU). In addition, the input unit 10 can also be implemented by a dedicated input circuit. The input unit 10 may be a digital circuit or an analog circuit.

The input unit 10 may be a part of a sensor including the sensor element 40, or may be a part of a reservoir computing device including the physical reservoir 20 and the output unit 30. That is, the reservoir computing device 100 may be removable between the sensor element 40 and the input unit 10, or may be removable between the input unit 10 and the physical reservoir 20.

The input unit 10 includes a conversion unit 11. The conversion unit 11 is connected to the sensor element 40 and the physical reservoir 20. The conversion unit 11 converts the external signal S1 input from the sensor element 40 into the converted signal S2. The conversion unit 11 may be a signal conversion circuit, or may be a microcontroller unit (MCU) or microprocessor unit (MPU) including a central processing unit (CPU). When the conversion unit 11 is a signal conversion circuit, a conversion process is implemented by a combination of elements and circuits. The conversion unit 11 may be a digital circuit or an analog circuit. When the conversion unit 11 is an MCU or an MPU, a conversion process is implemented in software computation processing. Generally, in reservoir computing, a weight between the external signal S1 and each node of the physical reservoir 20 may be set in the input unit 10. This weight is often determined randomly and fixedly, for example. In that case, the converted signal S2 is a signal obtained by multiplying the weight of the input unit 10 by the external signal S1 after the above-described conversion process.

The conversion unit 11 converts the external signal S1 into the converted signal S2 so that a dependency (second dependency) between an output signal S4 and a teacher signal S6 to be described later increases. The dependency between the output signal S4 and the teacher signal S6 when the external signal S1 is converted into the converted signal S2 is higher than a dependency between the output signal S4 and the teacher signal S6 when the external signal S1 is directly input to the physical reservoir 20 without going through the conversion unit 11. Dependency corresponds to the degree to which the teacher signal S6 can be obtained by linear conversion from the output signal S4.

Dependency between the output signal S4 and the teacher signal S6 can be confirmed, for example, by comparing mutual information between the output signal S4 and the teacher signal S6. The mutual information is a score that represents a measure of interdependence between two random variables in probability theory and information theory, and is an index that indicates their mutual dependency, including both linear and nonlinear relationships. It can be generally said that the higher the mutual information between the output signal S4 and the teacher signal S6, the higher the dependency between the output signal S4 and the teacher signal S6.

Whether or not the conversion from the external signal S1 to the converted signal S2 is a desired conversion that increases the dependency between the output signal S4 and the teacher signal S6 can be determined by the following procedure.

First, the output signal S4 from the physical reservoir 20 and the teacher signal S6, are obtained, and a mutual information between them (hereinafter referred to as a first mutual information) is obtained. Next, the output signal S4 from the physical reservoir 20 and the teacher signal S6 when a part corresponding to the conversion unit 11 is removed from the reservoir computing device 100 are obtained, and a mutual information between them (hereinafter referred to as a second mutual information) is obtained. The first mutual information and the second mutual information are compared, and when the first mutual information is greater than the second mutual information, it can be said that desired conversion has been performed.

The dependency between the output signal S4 and the teacher signal S6 may be evaluated using a correlation coefficient, a coefficient of determination, principal component analysis (PCA), canonical correlation analysis (CCA), multicollinearity, or the like.

The conversion unit 11 performs, for example, nonlinear calculation to convert the external signal S1 into the converted signal S2. The nonlinear calculation is limited to one in which the first mutual information is greater than the second mutual information by comparing the first mutual information with the second mutual information. The nonlinear calculation may be performed by signal processing using a conversion circuit, or may be calculation using software in a central processing unit.

The nonlinear calculation may include, for example, computation processing represented by y=ax². In the formula, y is the converted signal S2, a is a constant, and x is the external signal S1.

The nonlinear calculation may also include, for example, computation processing represented by y=aexp(b|x|). In the formula, y is the converted signal S2, a and b are constants, and x is the external signal S1.

When the external signal S1 is converted into the converted signal S2, it is expected that a distribution of the output signal S4 becomes wider. In other words, the conversion unit 11 may convert the external signal S1 into the converted signal S2 so that the distribution of the output signal S4 becomes wider. The conversion process for widening a distribution of the output signal S4 may be a logarithmic conversion or a histogram equalization used in signal processing, in addition to exponentiation such as the exponential conversion and the L2 norm.

The output signal S4 is a collection of signals output from the physical reservoir 20. The physical reservoir 20 outputs a plurality of signals, which are not identical and have a certain distribution. It is desirable that a variation in the distribution of the output signal S4 when the external signal S1 is converted into the converted signal S2 is wider than a variation in the distribution of the output signal S4 when the external signal S1 is directly input to the physical reservoir 20 without the conversion unit 11. That is, the reservoir computing device 100 is expected to have an effect of expanding a distribution of data as an output of the physical reservoir 20 by having the conversion unit 11, compared to when the external signal S1 is input as it is. When the distribution of the output signal S4 expands, the amount of information of the input signal increases even when the same physical reservoir 20 is used, thereby improving the accuracy of the reservoir computing device 100.

The conversion unit 11 may also convert signals using methods other than nonlinear conversion. For example, the conversion unit 11 may perform signal conversion using delay embedding, a filter bank, envelope power, logarithm/μ-law, a small-scale learner, or the like.

For example, when the conversion unit 11 applies delay embedding as a conversion process, the conversion unit 11 performs the delay embedding by the following procedures. The conversion unit 11 performs the delay embedding on an input signal s1, thereby converting the input signal s1 into a delay vector delayed by an embedding dimension. The delay embedding refers to setting a delay time t and an embedding dimension m, and generating, for example, the following m-dimensional vector z(t) (corresponding to the converted signal s2) from an input time-series signal u(t) (corresponding to the input signal s1). Scaling and normalization may be added as necessary in the delay embedding.

$$z ( t ) = {[ u ( t ) , u ( t - τ ) , u ( t - 2 τ ) , … u ( t - ( m - 1 ) τ ) ]}^{T} \qquad [ Math . 1 ]$$

According to Takens' theorem, when a state space of a smooth dynamical system has a topological dimension d, for any delay time t where the embedding dimension m exceeds 2d+1, the delay vector z(t) is a diffeomorphic embedding into the original phase space. In other words, z(t) can uniquely reconstruct the trajectory of the original system and reconstruct the phase space without distorting a temporal structure or nonlinear correlation.

Conversion by delay embedding is expected to have the following effects.

(1) Simultaneous acquisition of past information: Since a delay vector simultaneously inputs the past states up to (m−1)τ into a reservoir layer, the reservoir layer can simultaneously represent short-, medium-, and long-term temporal dependencies.

(2) Faithful reproduction of phase space: Original nonlinear dynamics represented by an input signal is reproduced without distortion within a reservoir layer, thereby improving expressive power.

(3) Improved prediction accuracy and classification performance: By explicitly incorporating a past history into an input, training errors are reduced compared to a direct scalar input of the related art, thereby enabling more robust prediction and classification.

As described above, conversion by delay embedding is expected to improve the performance of physical reservoir computing devices.

When the conversion unit 11 uses a conversion method based on a filter bank, K bandpass (or lowpass/highpass) filters are disposed in the conversion unit 11. The input time-series signal u(t) is passed through K filters in parallel to generate {h_k(t)} (k=1 to K). Each filter has a different center frequency f_k and bandwidth Δf_k, and decomposes spectral components of a signal to generate independent channels s_k(t)=(u×h_k)(t). z(t)=[s_1(t), s_2(t), s_3(t), . . . , s_K(t)]\hat{ }T which is obtained by vectorizing the obtained channel is a converted signal s2. Even in this case, it is possible to perform mean removal and standardization as necessary.

When the conversion unit 11 performs conversion using envelope extraction (envelope and power), an instantaneous complex envelope ũ(t)=u(t)+jH{u(t)} is obtained using Hilbert transform, and then an amplitude part e(t)=|ũ(t)| is normalized to obtain z(t)=e(t). z(t) corresponds to the converted signal S2.

When the conversion unit 11 performs conversion using μ-law compression, the compressed signal is delay-vectorized using v(t)=sgn(u(t))×ln(1+μ(u(t)))/ln(1+μ), thereby generating the converted signal S2.

When the conversion unit 11 performs conversion using wavelet decomposition, a mother wavelet y and a scale set {a_i} are selected, and a vector z(t)=[W_1(t), W_2(t), . . . . W_L(t)]\hat{ }T, which connects a coefficient sequence {W_i(t)}, is generated as the converted signal S2.

By applying these methods as a conversion method, the amplitude, frequency, and time resolution of the input signal can be enhanced in multiple ways, and it is expected that it is easy for the reservoir layer to learn nonlinear and nonstationary patterns that are difficult to capture with scalar time-series inputs of the related art.

The physical reservoir 20 is connected to the input unit 10 and the output unit 30. The physical reservoir 20 is configured to be able to perform nonlinear conversion of an input signal S3 from the input unit 10 and output it as the output signal S4 to the output unit 30.

The input signal S3 from the input unit 10 is input to the physical reservoir 20. For example, the input signal S3 is the same as the converted signal S2. The input signal S3 may not be the same as the converted signal S2. The physical reservoir 20 outputs the output signal S4 to the output unit 30.

The physical reservoir 20 is configured with a combination of real elements or circuits, and is obtained by implementing the concept of reservoir computing with the real elements or circuits. The physical reservoir 20 is may be, for example, an optical element that uses light, an electrical element that uses electricity, a magnetic element that uses magnetism, or an element that uses vibration or other mechanical behavior. When the physical reservoir 20 is an analog interface, it may include a digital-to-analog converter that digitally converts an output from the physical reservoir 20. The physical reservoir 20 may also be implemented in a programmable logic device (PLD) such as a field-programmable gate array (FPGA). When implementing reservoir computing using an FPGA, a certain degree of change can be made to the type of sensor, and the like. However, there are limitations on the number of inputs and outputs (I/O) and the scale of mounting circuits, and there are problems similar to those of physical reservoirs using other electronic devices. Even in such a case, it is effective to introduce the conversion unit 11, and particularly, in a reservoir computing device implemented in an FPGA, the function of the conversion unit 11 itself can be implemented as a circuit of the FPGA.

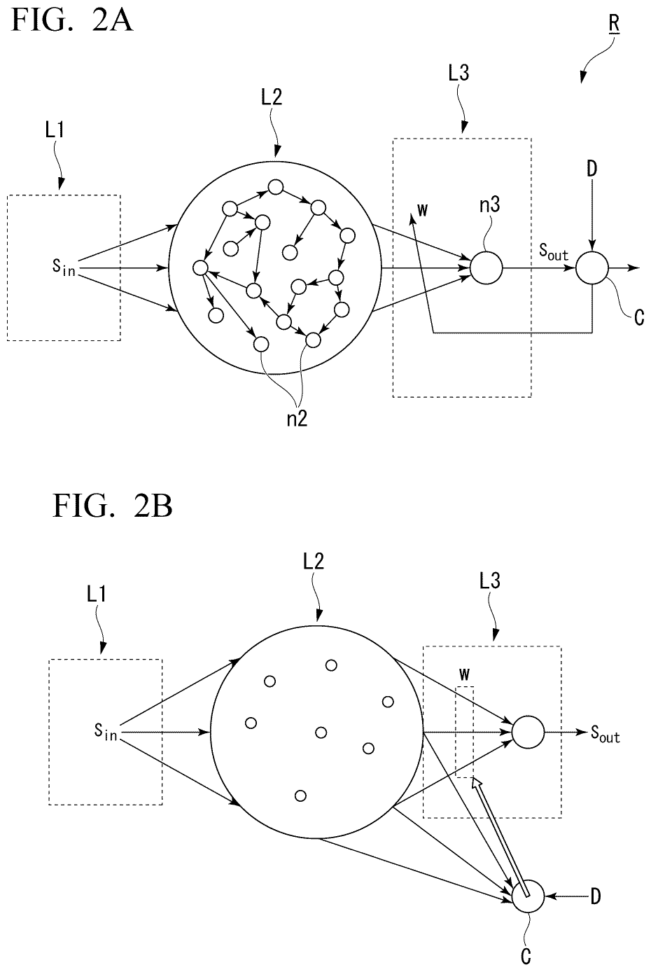

FIG. 2A is a conceptual diagram of the reservoir computing implemented by the reservoir computing device 100 according to the first embodiment. The reservoir computing process is performed in a reservoir R.

The reservoir R includes an input layer L1, a reservoir layer L2, and an output layer L3. The input layer L1 and the output layer L3 are connected to the reservoir layer L2.

The input layer L1 inputs an input signal Sᵢₙ to the reservoir layer L2. The input signal Sᵢₙ corresponds to the input signal S3 obtained by converting the output signal S1. The input layer L1 corresponds to, for example, the input unit 10.

The reservoir layer L2 stores the input signal Sᵢₙ input from the input layer L1 and converts it into another signal. The reservoir layer L2 includes a plurality of nodes n2. The nodes n2 are equivalent to neurons in a neural circuit, and the connections between the nodes n2 are equivalent to synapses. The number of nodes n2 does not matter.

Each of the nodes n2 may be fully coupled to the input layer L1. Each of the nodes n2 may be fully coupled to the output layer L3. Each of the nodes n2 may be coupled to one or more other nodes n2 or may not be connected to the other nodes n2.

Each of the nodes n2 may be coupled to all of the other nodes n2 in the reservoir layer L2 or may be coupled to some nodes n2 in the reservoir layer L2. In a general reservoir computing, the connections between the nodes n2 are random. In the physical reservoir, the connections between the nodes n2 may have coupling weights that are optimized during the design phase.

The couplings between the nodes n2 may include recursive couplings. Recursive couplings are couplings where an output returns to an input. For example, a signal output from one node n2 at time t may return to the node n2 that outputs a signal at time t+1 or later. This occurs when a signal output from one node n2 propagates through other nodes n2 and returns to the original node n2. In this manner, a coupling relationship in which an output from a certain node n2 is input to the node n2 again is referred to as a recursive coupling.

Coupling coefficients that indicate coupling weights are set between the nodes n2. A signal input to the node n2 propagates between the nodes n2. A signal propagated to a certain node n2 is nonlinearly converted by an activation function of the node n2, then multiplied by a coupling coefficient, and propagated to the next node n2.

The coupling coefficient between the nodes n2 can be set arbitrarily within a range that is optimal for the dynamic range of the input signal and the domain for nonlinear conversion mechanism in the reservoir layer. For example, the coupling coefficient between the nodes n2 may be set in the range from −1.0 to +1.0. A coupling coefficient between the nodes n2 can be set arbitrarily in the range of −1.0 to +1.0. The coupling coefficient between the nodes n2 is set, for example, by a random number.

The reservoir layer L2 corresponds to the physical reservoir 20. The physical reservoir 20 includes a plurality of physical nodes that correspond to the nodes n2 in the reservoir layer L2. The physical nodes are physical elements that can process the nodes n2. The physical node may have a function that represents the coupling coefficient between the nodes n2. For example, in the case of a physical reservoir using a MEMS resonator, a natural frequency and a damping coefficient correspond to coupling coefficients.

In addition, a virtual node method may be used as another implementation form of the physical reservoir 20. The virtual node method is a method in which a single physical element is used, a signal is input in a time-division manner, and a signal output from the physical element for a certain unit time is treated as an output of the reservoir layer L2. In this case, the number of nodes in the physical reservoir 20 is one, but a plurality of time-division outputs are virtually treated as outputs of the reservoir layer L2. Even in this case, a similar effect can be obtained by incorporating an appropriate conversion process into the input signal. The plurality of nodes in the present embodiment include both a plurality of physical nodes that actually exist and a plurality of virtual physical nodes.

The node n2 is connected to a node n3 of the output layer L3. For example, a signal from each of the nodes n2 is input to the node n3 of the output layer L3. The signal from each of the nodes n2 corresponds to the output signal S4 from the physical reservoir 20. The output signal S4 has more dependency with the teacher signal S6 by converting the external signal S1 into the converted signal S2.

The output layer L3 receives an input of a signal from the reservoir layer L2 and outputs an output signal Sₒᵤₜ based on the signal. The output signal Sₒᵤₜ corresponds to an external output signal S5 of the reservoir computing device 100. The output layer L3 has, for example, the node n3. A coupling coefficient between the node n2 of the reservoir layer L2 and the node n3 of the output layer L3 is updated by learning of the reservoir R. Learning is performed by updating the coupling coefficient between the node n2 of the reservoir layer L2 and the node n3 of the output layer L3.

A coupling coefficient w between the node n2 of the reservoir layer L2 and the node n3 of the output layer L3 is updated on the basis of a comparison result in a learner C. The learner C calculates a difference between the output signal Sₒᵤₜ with a teacher signal D, and obtains an update amount of the weight of the output layer L3 by a method such as a recursive least squares method.

The output layer L3 corresponds to the output unit 30 of the reservoir computing device 100. The output unit 30 is configured to be able to apply a weight Wt to the output signal S4. The weight Wt is a coefficient applied to the output signal S4 and corresponds to the coupling coefficient described above.

In online learning, the weight Wt is updated on the basis of a comparison result between the external output signal S5 and the teacher signal S6. The teacher signal S6 is stored, for example, in a memory. The comparison with the external output signal S5 can be performed by reading the teacher signal S6 from the memory. The comparison between the external output signal S5 and the teacher signal S6 can be performed, for example, by a microcontroller unit (MCU) or a microprocessor unit (MPU) including a central processing unit (CPU).

In batch learning, the weight Wt can be calculated by performing an inverse matrix calculation from the output signal S4 and the teacher signal S6 when data to be used for learning is input. At this time, regularization processing may be performed to improve generalization performance. For example, methods such as ridge regression may be used for regularization. In the case of batch learning, the learner C is disposed at the position shown in FIG. 2B and functions as a computing unit for inversion matrix calculation and regularization processing.

The output unit 30 performs linear conversion in which the weight Wt is applied to the output signal S4. The output unit 30 may be a signal conversion circuit, or a microcontroller unit (MCU) or a microprocessor unit (MPU) including a central processing unit (CPU). When the output unit 30 is a signal conversion circuit, signal processing of applying the weight Wt is implemented by a combination of elements and circuits. When the output unit 30 is an MCU or an MPU, the output signal S4 is converted into the external output signal S5 in software computation processing. When the output unit 30 is implemented by a signal conversion circuit, the output unit 30 may be configured using an analog product-sum computing unit using a memristor element, which is a resistance change element.

The reservoir computing device 100 can be manufactured by connecting the units of the sensor element 40, the input unit 10, the physical reservoir 20, and the output unit 30. Each of the units can be manufactured by a known method.

Next, the operation of the reservoir computing device 100 will be described. The reservoir computing device 100 can perform a setting process, a learning process, and an inference process.

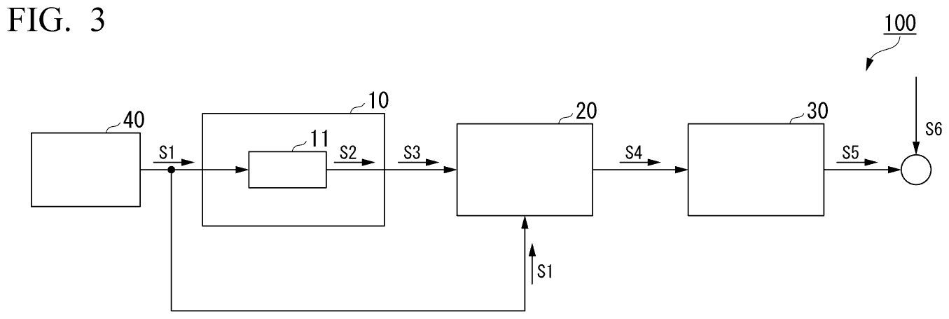

The setting process of the reservoir computing device 100 is a process of setting a method of signal conversion in the conversion unit 11. FIG. 3 is a diagram showing the setting process of the reservoir computing device 100 according to the first embodiment.

During the setting process, the weight Wt of the output unit 30 is fixed. The weight Wt of the output unit 30 may be set randomly, or may be set as a result of a certain learning process.

The setting process is performed by the following procedure. First, the external signal S1 detected by the sensor element 40 is converted into the converted signal S2 by the conversion unit 11. Then, the input signal S3 based on the converted signal S2 is input to the physical reservoir 20 to obtain the output signal S4. Then, in order to confirm the dependency between the output signal S4 and the teacher signal S6, the first mutual information between the output signal S4 and the teacher signal S6 is obtained.

As a method of evaluating the validity of the conversion mechanism, in addition to confirming the dependency between the output signal S4 and the teacher signal S6 as described above, the validity may also be determined based on the results of the reservoir computing using the weight Wt of the trained output unit 30, i.e., the match between the output of the reservoir computing and the teacher signal.

Next, a signal propagation path is switched such that the external signal S1 is directly input to the physical reservoir 20. The signal path can be switched, for example, by a switch element or the like. The external signal S1 is directly input to the physical reservoir 20 to obtain the output signal S4. Then, in order to confirm the dependency between the output signal S4 and the teacher signal S6, the second mutual information between the output signal S4 and the teacher signal S6 is obtained.

Next, the first mutual information is compared with the second mutual information to confirm whether the first mutual information is greater than the second mutual information. When the first mutual information is greater than the second mutual information, the conversion unit 11 performs an appropriate conversion. When the first mutual information is less than the second mutual information, the conversion process in the conversion unit 11 is changed.

Here, the setting process may be performed before the shipment of the reservoir computing device 100. For example, the setting process may not be performed when the sensor element 40 performs actual sensing. In addition, when a task or the like required of the reservoir computing device 100 changes, the setting process may be performed. In addition, the setting process may be performed in the stage of design of the physical reservoir. In addition, by configuring the conversion unit 11 to be programmable, even after the reservoir computing device 100 has been shipped, it may be rewritten to the optimal conversion method at any time according to the operating environment of the reservoir computing device 100, the type of sensor element 40, and its changes over time.

The learning process is performed in accordance with the procedure shown in FIG. 3. The learning process is a process of updating the weight Wt of the output unit 30. The learning process is performed in a state where the signal conversion process of the conversion unit 11 is set and fixed. The learning process may be online or batch learning.

During the online learning process, first, the external signal S1 detected by the sensor element 40 is converted into the converted signal S2 by the conversion unit 11. Then, the input signal S3 based on the converted signal S2 is input to the physical reservoir 20 to obtain the output signal S4. The weight Wt is applied to the output signal S4 by the output unit 30, and the output signal S4 becomes the external output signal S5. During the learning process, the external output signal S5 is compared with the teacher signal S6. The weight Wt is updated in the output unit 30 on the basis of a comparison result between the external output signal S5 and the teacher signal S6. The reservoir computing device 100 is trained so as to minimize the error between the external output signal S5 and the teacher signal S6, and the weight Wt of the output unit 30 is determined. For example, the error can be the squared error in a regression problem or the percentage of correct answers between output labels and teacher labels in a classification problem. During batch learning processing, the weight Wt of the output unit 30 is determined by performing processes such as inverse matrix calculation and regularization on the output signal S4 and the teacher signal S6.

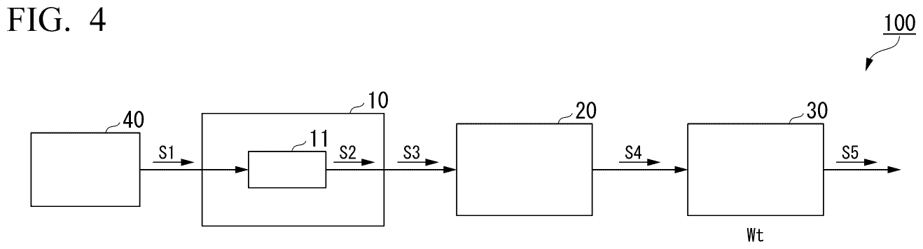

FIG. 4 is a diagram showing the inference process of the reservoir computing device 100 according to the first embodiment. The inference process is performed in a state where the weight Wt of the output unit 30 is fixed on the basis of a learning result. The inference process is performed under the condition where the signal conversion process of the conversion unit 11 is set and fixed. During the inference process, the external output signal S5 is output based on the external signal S1 detected by the sensor element 40.

Even during inference process, the external signal S1 detected by the sensor element 40 is converted into the converted signal S2 by the conversion unit 11. Then, the input signal S3 based on the converted signal S2 is input to the physical reservoir 20 to obtain the output signal S4. The weight Wt is applied to the output signal S4 by the output unit 30 to become the external output signal S5. The external output signal S5 is output from the reservoir computing device 100.

The reservoir computing device 100 according to the first embodiment can improve the versatility of the reservoir computing device 100 by converting the external signal S1 and inputting it to the physical reservoir 20. The structure of the physical reservoir 20 is fixed, and it is difficult to significantly change the processing in the physical reservoir 20. On the other hand, the reservoir computing device 100 according to the first embodiment can change the input signal S3 input to the physical reservoir 20 by converting the external signal S1 into the converted signal S2. This is because the input unit 10 converts the external signal S1 into the input signal S3, and the input signal S3 is tuned depending on the conditions of the conversion. For this reason, the reservoir computing device 100 according to the first embodiment can tune the processing in the reservoir computing device 100 even when a task required for the reservoir computing device 100 changes. For example, it is the case when the sensor elements 40 to be used is changed.

In addition, the reservoir computing device 100 according to the first embodiment can improve the accuracy of the estimated solution of the reservoir computing device 100 by converting the external signal S1 into the input signal S3.

### Second Embodiment

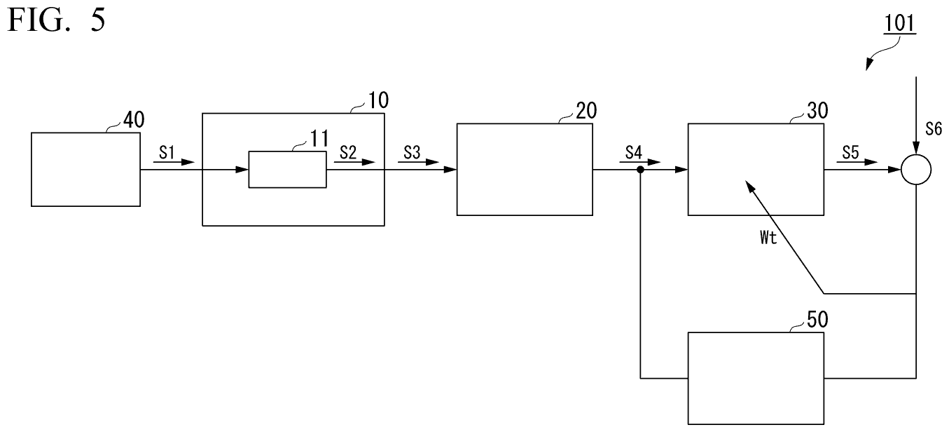

FIG. 5 is a schematic diagram of a reservoir computing device 101 according to a second embodiment. The reservoir computing device 101 includes, for example, an input unit 10, a physical reservoir 20, an output unit 30, a sensor element 40, and an evaluation unit 50. The reservoir computing device 101 differs from the reservoir computing device 100 in that it includes the evaluation unit 50. In the reservoir computing device 101, the same components as those in the reservoir computing device 100 are given the same reference numerals and will not be described.

The evaluation unit 50 is configured to be able to monitor the dependency (second dependency) between an output signal S4 and a teacher signal S6. The evaluation unit 50 is connected to, for example, an output terminal of the physical reservoir 20 and a memory in which the teacher signal S6 is stored.

The evaluation unit 50 may be a signal comparison circuit, or may be a microcontroller unit (MCU) or microprocessor unit (MPU) including a central processing unit (CPU). When the evaluation unit 50 is a signal comparison circuit, the evaluation unit 50 performs a process of comparing signals by a combination of elements and circuits. When the evaluation unit 50 is an MCU or an MPU, the output signal S4 and the teacher signal S6 are compared in software computation processing.

The evaluation unit 50 evaluates, for example, the dependency between the output signal S4 and the teacher signal S6. The dependency between the output signal S4 and the teacher signal S6 may be evaluated by comparing a mutual information between the output signal S4 and the teacher signal S6. The dependency between the output signal S4 and the teacher signal S6 may also be evaluated using a correlation coefficient, a coefficient of determination, principal component analysis (PCA), canonical correlation analysis (CCA), multicollinearity, or the like.

The reservoir computing device 101 according to the second embodiment has the same effect as that of the reservoir computing device 100 according to the first embodiment. Furthermore, the reservoir computing device 101 can monitor the dependency between the output signal S4 and the teacher signal S6 by the evaluation unit 50. Since the input unit 10 converts an external signal S1 into an input signal S3, the dependency between the output signal S4 and the teacher signal S6 is high in principle. On the other hand, when unexpected data or the like that has not been in the training data is input, the dependency may decrease. For this reason, by monitoring the dependency in the evaluation unit 50, abnormalities in the external signal S1 can be detected. Furthermore, even when an abnormality such as deterioration over time occurs in the physical reservoir 20, the dependency varies, and thus the evaluation unit 50 can also detect such an abnormality.

### Third Embodiment

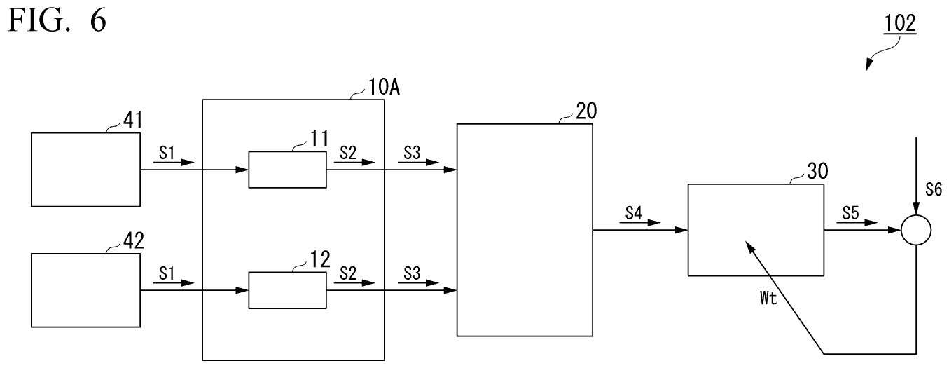

FIG. 6 is a schematic diagram of a reservoir computing device 102 according to a third embodiment. The reservoir computing device 102 includes, for example, an input unit 10A, a physical reservoir 20, an output unit 30, a sensor element 41, and a sensor element 42. The reservoir computing device 102 differs from the reservoir computing device 100 in that it includes a plurality of sensor elements and conversion units. In the reservoir computing device 102, the same components as those in the reservoir computing device 100 are given the same reference numerals, and will not be described.

The sensor element 41 and sensor element 42 used can be the same as the sensor element 40 according to the first embodiment. For example, the sensor element 41 and the sensor element 42 are elements that detect different pieces of information. In this case, the sensor element 41 and the sensor element 42 output different external signals. Here, a case where there are two sensor elements is exemplified, but the number of sensor elements may be more than two.

The input unit 10A includes a conversion unit 11 and a conversion unit 12. The conversion unit 11 and conversion unit 12 used can be the same as the conversion unit 11 according to the first embodiment. The conversion unit 11 converts an external signal S1 from the sensor element 41 into a converted signal S2. The conversion unit 12 converts the external signal S1 from the sensor element 42 into the converted signal S2. The conversion processes of the conversion units 11 and 12 may be the same or different. Here, a case where there are two conversion units is exemplified, but the number of conversion units may be more than two. The number of conversion units may correspond to the number of sensor elements.

The converted signal S2 converted by each of the conversion unit 11 and the conversion unit 12 becomes an input signal S3 and is input to the physical reservoir 20.

The reservoir computing device 102 according to the third embodiment has the same effect as that of the reservoir computing device 100 according to the first embodiment. In addition, the reservoir computing device 102 can perform more complex processing by using plurality of different external signals S1. For this reason, the reservoir computing device 102 can perform an appropriate output even for more complex tasks.

### Fourth Embodiment

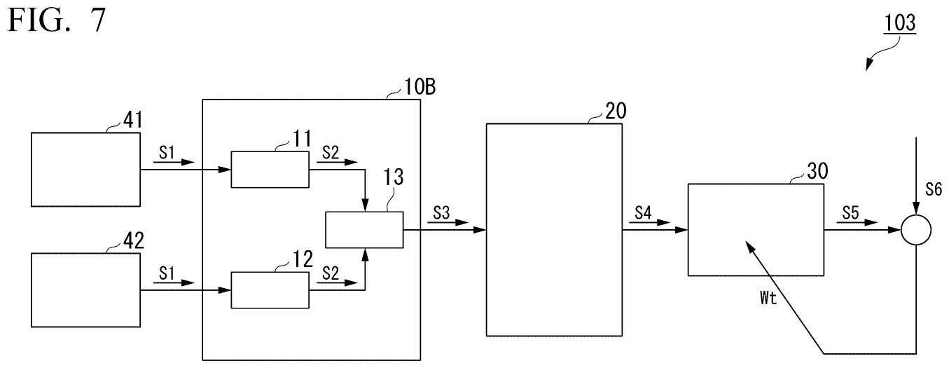

FIG. 7 is a schematic diagram of a reservoir computing device 103 according to a fourth embodiment. The reservoir computing device 103 includes, for example, an input unit 10B, a physical reservoir 20, an output unit 30, a sensor element 41, and a sensor element 42. The reservoir computing device 103 differs from the reservoir computing device 100 in that it includes a plurality of sensor elements and the configuration of the input unit 10B is different. In the reservoir computing device 103, the same components as those in the reservoir computing device 100 are given the same reference numerals and will not be described.

The sensor element 41 and the sensor element 42 are the same as those in the reservoir computing device 102 according to the third embodiment.

The input unit 10B includes a conversion unit 11, a conversion unit 12, and a junction unit 13. The conversion unit 11 and the conversion unit 12 are the same as those in the reservoir computing device 102 according to the third embodiment.

The junction unit 13 is configured to be able to merge converted signals S2 converted by the conversion unit 11 and the conversion unit 12. The junction unit 13 is configured to be able to input a signal based on the merged junction signal to the physical reservoir 20 as an input signal S3.

The input signal S3 may be the same as the junction signal, or may be a converted signal of the junction signal. For example, the input signal S3 may be the square root of the junction signal. For example, when the conversion process in the conversion unit 11 and the conversion unit 12 is computation processing represented by y=ax², the junction signal is the sum of these converted signals, and the square root of this summed junction signal may be obtained as the input signal S3. In this case, the input signal S3 is obtained by calculating the L2 norm of the external signal S1.

The junction unit 13 may be a signal processing circuit, or may be a microcontroller unit (MCU) or microprocessor unit (MPU) including a central processing unit (CPU). When the junction unit 13 is a signal processing circuit, the conversion process and junction process are implemented by a combination of elements and circuits. When the junction unit 13 is an MCU or an MPU, the conversion process and junction process are implemented in software computation processing.

The reservoir computing device 103 according to the fourth embodiment has the same effect as that of the reservoir computing device 100 according to the first embodiment. In addition, the reservoir computing device 103 can compress the dimension of a signal input to the physical reservoir 20 by merging the signals at the junction unit 13. The reservoir computing device 103 according to the fourth embodiment can handle multi-dimensional input signals even when the configuration of the physical reservoir 20 is fixed, and is highly versatile.

### Fifth Embodiment

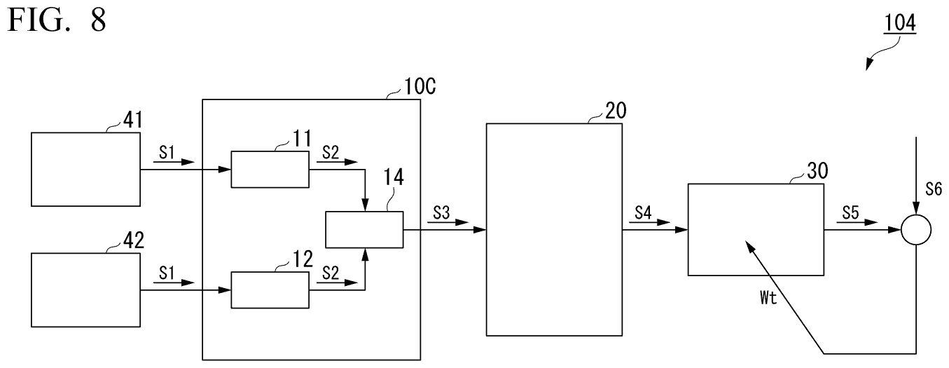

FIG. 8 is a schematic diagram of a reservoir computing device 104 according to a fifth embodiment. The reservoir computing device 104 includes, for example, an input unit 10C, a physical reservoir 20, an output unit 30, a sensor element 41, and a sensor element 42. The reservoir computing device 104 differs from the reservoir computing device 100 in that it includes a plurality of sensor elements and the configuration of the input unit 10C is different. In the reservoir computing device 104, the same components as those in the reservoir computing device 100 are given the same reference numerals and will not be described.

The sensor element 41 and the sensor element 42 are the same as those in the reservoir computing device 102 according to the third embodiment.

The input unit 10C includes a conversion unit 11, a conversion unit 12, and an analysis unit 14. The conversion unit 11 and the conversion unit 12 are the same as those in the reservoir computing device 102 according to the third embodiment.

The analysis unit 14 is configured to be able to analyze main components of converted signals S2 converted by the conversion units 11 and 12 and input a signal having a high contribution among main components to the physical reservoir 20 as an input signal S3. That is, the analysis unit 14 extracts a signal with a high importance from the converted signals S2 and inputs it to the physical reservoir 20. The contribution criteria can be set arbitrarily by a user and freely designed in accordance with a task imposed on the reservoir computing device 104.

The analysis unit 14 may use the signal with a high contribution as the input signal S3 as it is, or may use a signal obtained on the basis of the signal with a high contribution as the input signal S3. The analysis unit 14 may perform singular value decomposition and set the input signal S3 based on the magnitude of a singular value.

The analysis unit 14 may be a signal processing circuit, or may be a microcontroller unit (MCU) or microprocessor unit (MPU) including a central processing unit (CPU). When the analysis unit 14 is a signal processing circuit, the analysis process is implemented by a combination of elements and circuits. When the analysis unit 14 is an MCU or an MPU, the analysis process is implemented in software computation processing.

The reservoir computing device 104 according to the fifth embodiment has the same effect as that of the reservoir computing device 100 according to the first embodiment. In addition, the reservoir computing device 104 can compress the dimension of a signal input to the physical reservoir 20 by using the analysis unit 14. The reservoir computing device 104 according to the fifth embodiment can handle multi-dimensional information even when the configuration of the physical reservoir 20 is fixed, and is highly versatile.

### Sixth Embodiment

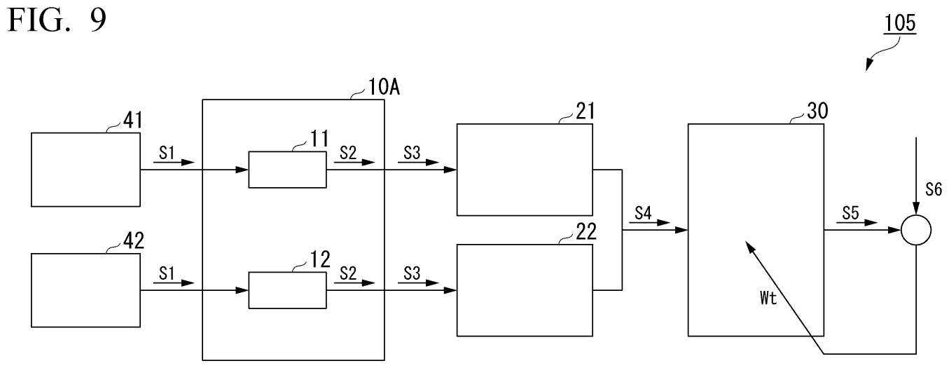

FIG. 9 is a schematic diagram of a reservoir computing device 105 according to a sixth embodiment. The reservoir computing device 105 includes, for example, an input unit 10A, a physical reservoir 21, a physical reservoir 22, an output unit 30, a sensor element 41, and a sensor element 42. The reservoir computing device 105 differs from the reservoir computing device 100 in that it includes a plurality of sensor elements, conversion units, and physical reservoirs. In the reservoir computing device 105, the same components as those in the reservoir computing device 100 are given the same reference numerals and will not be described.

The sensor element 41, the sensor element 42, and the input unit 10A are the same as those in the reservoir computing device 102 according to the third embodiment.

The physical reservoir 21 and the physical reservoir 22 are the same as the physical reservoir 20 according to the first embodiment. The input signal S3 based on the converted signal S2 converted by the conversion unit 11 is input to the physical reservoir 21. The input signal S3 based on the converted signal S2 converted by the conversion unit 12 is input to the physical reservoir 22. Here, a case where there are two physical reservoirs is exemplified, but the number of physical reservoirs may be greater. The number of physical reservoirs may correspond to the number of conversion units.

The outputs from the physical reservoir 21 and the physical reservoir 22 are merged together and input to the output unit 30 as an output signal S4. Here, a case where there is one output unit 30 is exemplified, but the number of output units 30 may be plural.

The reservoir computing device 105 according to the sixth embodiment has the same effect as that of the reservoir computing device 100 according to the first embodiment. In addition, the reservoir computing device 105 includes a plurality of physical reservoirs, and thus can perform nonlinear conversion according to different external signals in each of the physical reservoirs. The plurality of reservoirs as described here may be arranged in parallel, or a plurality of reservoirs may be arranged in series. Even in this case, similar performance improvements can be expected.

### Seventh Embodiment

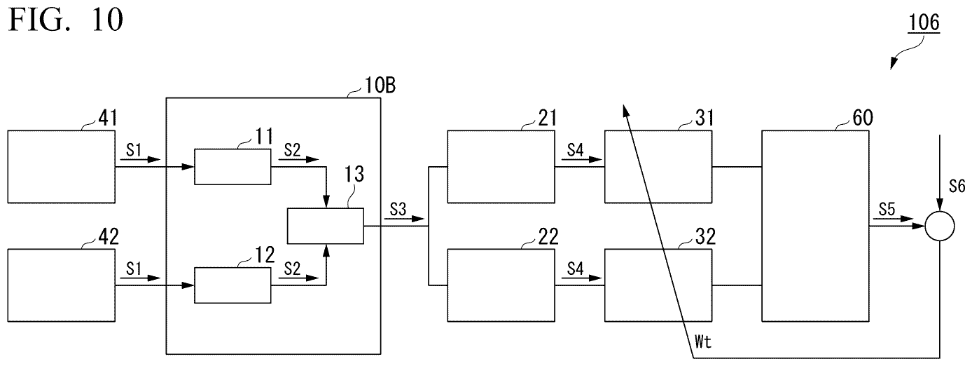

FIG. 10 is a schematic diagram of a reservoir computing device 106 according to a seventh embodiment. The reservoir computing device 106 includes, for example, an input unit 10B, a physical reservoir 21, a physical reservoir 22, an output unit 31, an output unit 32, an ensemble output unit 60, a sensor element 41, and a sensor element 42. The same components as those in the above-mentioned embodiments are given the same reference numerals, and the description thereof will be omitted.

The output unit 31 and the output unit 32 are similar to the output unit 30 according to the first embodiment. The output unit 31 receives an input of an output signal S4 from the physical reservoir 21, and the output unit 32 receives an input of an output signal S4 from the physical reservoir 22.

The ensemble output unit 60 performs ensemble calculation in machine learning using the outputs from the output unit 31 and the output unit 32, and outputs the final external output signal S5. The ensemble calculation may use an average of the outputs from the output units 31 and 32, or may use the result of a majority vote.

The reservoir computing device 106 according to the seventh embodiment has the same effect as those of the reservoir computing device 100 according to the first embodiment. The reservoir computing device 106 can improve the robustness of prediction by using ensemble calculation, which is expected to be effective in terms of both prediction accuracy and uncertainty.

Here, an example in which there are a plurality of sensor elements 41 and 42 and the input unit 10B includes a plurality of conversion units 11 and 12 is shown, but the number of thereof may be one. As described above, the conversion unit 11 and the conversion unit 12 may be the same or different. Each of the conversion units 11 and 12 may improve dependency between the outputs of the physical reservoirs 21 and 22 connected thereto and a teacher signal S6. In addition, the conversion unit 11 and the physical reservoir 21 may be connected without including a junction unit 13, or the conversion unit 12 and the physical reservoir 22 may be connected.

### Eighth Embodiment

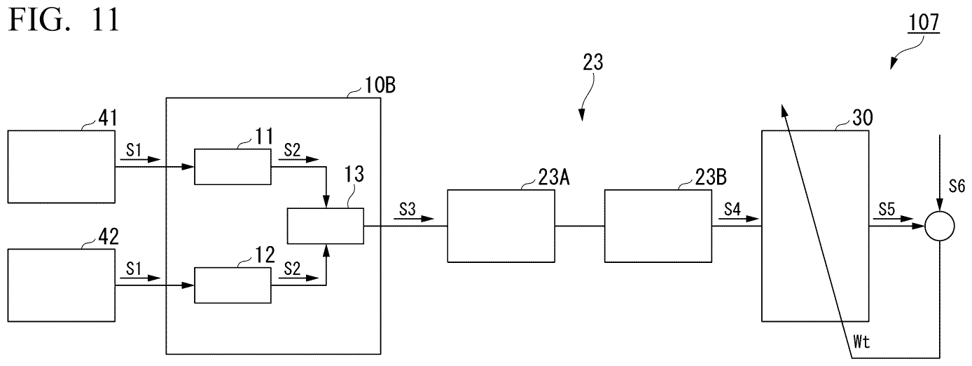

FIG. 11 is a schematic diagram of a reservoir computing device 107 according to an eighth embodiment. The reservoir computing device 107 includes, for example, an input unit 10B, a physical reservoir unit 23A, a physical reservoir unit 23B, an output unit 30, a sensor element 41, and a sensor element 42. The same components as those in the above-mentioned embodiment are given the same reference numerals, and the description thereof will be omitted.

The physical reservoir 23 includes the reservoir unit 23A and the reservoir unit 23B. The reservoir unit 23A and the reservoir unit 23B are connected in series between the input unit 10B and the output unit 30. The reservoir unit 23A receives a signal from the input unit 10B and outputs the signal to the reservoir unit 23B. The reservoir unit 23B receives a signal from the reservoir unit 23A and outputs the signal to the output unit 30. The reservoir units 23A and 23B each have the same function as the above-mentioned physical reservoir 20, and the physical reservoirs can be considered to be connected in series. The conversion unit 11 and the conversion unit 12 each improve the dependency between an output signal S4 from the reservoir unit 23B and a teacher signal S6.

The reservoir computing device 107 according to the eighth embodiment has the same effects as those of the reservoir computing device 100 according to the first embodiment. The reservoir computing device 107 can handle complex time-series signals because the reservoir units 23A and 23B are connected in series, allowing each layer to acquire different time scales and intermediate representations. In this configuration, an output layer may also be provided in the reservoir unit 23A. In this case, adjustments can be made in accordance with a function required for the layer. For example, when required function is to remove long-period components, a signal can be created by removing a long-period teacher signal from the input signal, and this signal can be used as a training signal.

Here, an example in which there are a plurality of sensor elements 41 and 42 and the input unit 10B includes a plurality of conversion units 11 and 12 is shown, but the numbers thereof may be one. In addition, as mentioned above, the conversion unit 11 and the conversion unit 12 may be the same or different. Further, the conversion unit 11 and the conversion unit 12 may be connected to the reservoir unit 23A without a junction unit 13.

### Ninth Embodiment

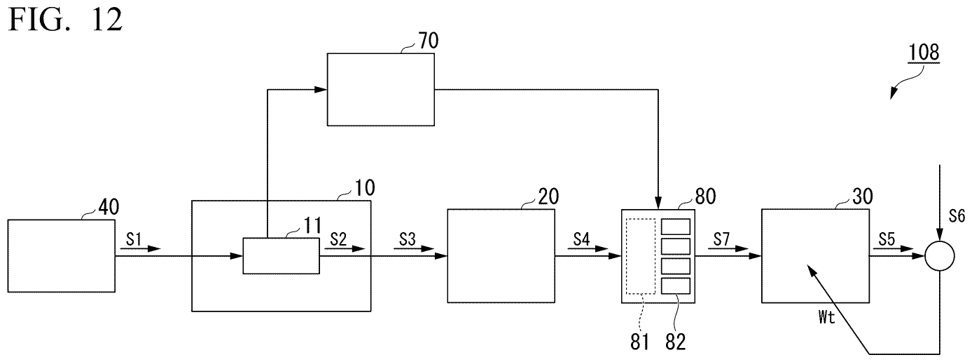

FIG. 12 is a schematic diagram of a reservoir computing device 108 according to a ninth embodiment. The reservoir computing device 108 includes, for example, an input unit 10, a physical reservoir 20, an output unit 30, a sensor element 40, an evaluation selection unit 70, and an acquisition unit 80. The same components as those in the above-mentioned embodiments are given the same reference numerals, and the description thereof will be omitted.

The evaluation selection unit 70 may be, for example, a microcontroller unit (MCU) or microprocessor unit (MPU) including a central processing unit (CPU). The evaluation selection unit 70 may be a signal converter, or an application-specific integrated circuit (ASIC) for that processing.

The evaluation selection unit 70 obtains a dependency (first dependency) between an input signal S3 and an output signal S4 and selects the dependency (first dependency) that satisfies a predetermined criterion. The output signal S4 is a state signal output from each physical node, and there are a plurality of output signals S4. The first dependency is obtained between each output signal S4 and the input signal S3.

The input signal S3 is a signal to be input to the physical reservoir 20 and corresponds to a converted signal S2 converted by the conversion unit 11. The converted signal S2 is obtained by converting an external signal S1 so that a dependency (second dependency) between the output signal S4 and a teacher signal S6 increases.

When an appropriate conversion process is given (when the converted signal S2 is appropriate), it is expected that a projection residual of the teacher signal S6 with respect to a column space (nodes) of a reservoir state matrix, which indicates a time series of the output signal S4 from the physical reservoir 20, will be small. This indicates that the conversion process improves the linearity between the reservoir state matrix and the teacher signal S6. As a result, information including the features of the teacher signal S6 (frequency components, delay components, polynomial terms, and the like) is aggregated into a small number of independent components in the reservoir state matrix. That is, among a plurality of physical nodes that configure the physical reservoir 20, physical nodes that are principal components strongly corresponding to the teacher signal S6 configure a main channel for signal propagation. As a result, the plurality of physical nodes that configure the physical reservoir 20 tend to be separated into physical nodes that are highly dependent on the converted signal S2 and physical nodes that are less dependent on the converted signal S2. That is, in response to variations in the converted signal S2, some physical nodes exhibit behavior that corresponds to the variations in the converted signal S2, while the remaining physical nodes exhibit little change in behavior in response to variations in the converted signal S2.

The evaluation selection unit 70 evaluates the dependency between the converted signal S2 (or the input signal S3 including the converted signal S2) and the output signal S4, and selects physical nodes with high dependency as selected nodes and physical nodes with low dependency as unselected nodes.

The first dependency is an index such as the sensitivity of each physical node with respect to the converted signal S2. The first dependency can be obtained, for example, using any one of a mutual information amount between each output signal S4 and the converted signal S2, a maximum cross-correlation between each output signal S4 and the converted signal S2, a canonical correlation coefficient based on canonical correlation analysis (CCA), or a coefficient of determination indicating an error between a predicted value output by the reservoir computing device and a teacher signal.

The mutual information amount can be obtained using known methods. When using the mutual information amount, it can be said that the greater the mutual information amount, the stronger the dependency.

The maximum cross-correlation can be obtained using known methods. For example, the maximum cross-correlation can be obtained based on a cross-correlation function.

The canonical correlation coefficient based on canonical correlation analysis (CCA) is an index that measures a correlation structure between the state matrix of the physical reservoir 20 and the converted signal S2 using the most highly correlated linear combination (canonical variates) and represents a linear relationship. It can be said that the greater the correlation, the stronger the dependency.

Node selection using canonical correlation analysis (CCA) selects a node to be used for output based on a relationship between a converted signal (a feature group obtained by converting an input) and each node time series of the physical reservoir 20. First, a linear combination with the highest correlation is obtained between a converted signal group and an output group of the physical reservoir 20. This process is achieved by performing canonical correlation analysis (CCA). In the canonical correlation analysis (CCA), the importance of each node is evaluated using the weight on the reservoir side or an obtained canonical variable (a converted representative time series).

Specifically, (A) the magnitude of a weight vector on the physical reservoir 20 side and (B) a correlation value between the obtained canonical variable and each node time series are used as node scores, and nodes with high scores are selected from a higher rank.

Since simply selecting based on the magnitude of a weight may result in misclassification, the following measures may be used in practice. Mean-centering and standardization based on learning data, application of CCA with regularization according to the number of samples, scoring combined with a correlation between a weight norm and a canonical variable, and evaluation and stability confirmation of selection results using verification data (multiple trials, a permutation test, or the like) may be performed. By using these methods in combination, high prediction accuracy can be maintained even with a small number of nodes. A reduction in nodes according to a task can be achieved by the above-mentioned methods.

When a coefficient of determination that indicates an error between a predicted value (external output signal S5) output by the reservoir computing device and the teacher signal S6 is used, for example, a Greedy Algorithm can be used. The Greedy algorithm is a computational method that is often used in optimization problems. A case where an error is obtained using a combination of some physical nodes (first combination) among a plurality of physical nodes configuring the physical reservoir 20 is compared with a case where an error is obtained using a different combination of physical nodes (second combination), and the combination with the smallest error is a combination that is suitable as selected nodes. This process is performed while changing the combination of physical nodes to obtain an optimal combination of selected nodes.

The criterion for distinguishing between a selected node and an unselected node by the evaluation selection unit 70 is determined based on whether the first dependency satisfies a predetermined criterion. The predetermined criterion can be set by a user in accordance with an evaluation method for the first dependency, a task assigned to the reservoir computing device 108, or the like. For example, as the predetermined criterion, a criterion for determining whether the first dependency exceeds a threshold value may be set, or a criterion for selecting nodes in order up to a K-th node (where K is an arbitrary integer) from a node with the highest first dependency may be set.

In addition, when selecting selected nodes, the evaluation selection unit 70 may use a p-value (α) according to a permutation test, may use stability selection, or may use an algorithm such as LASSO.

For example, the selection according to the permutation test is performed by the following steps.

First step: A performance index S_{full} is acquired using a baseline model (using all nodes).

Second step: For each node i, a state without information is generated by replacing an output sequence with a random sequence, and a performance index Sᵢ is measured multiple times using the same training procedure.

Third step: A p-value is calculated from the performance index S_{full} and Sᵢ Fourth step: A significance level a and multiple comparison correction are applied to select nodes where p<α.

Fifth step: A final model is retrained using only the selected nodes, and it is confirmed whether performance degradation is within an acceptable range.

When the evaluation selection unit 70 selects a selected node once, the evaluation selection unit 70 may then fix it or may reselect it in accordance with a predetermined rule. For example, the evaluation selection unit 70 may reselect a selected node at a fixed cycle or may be set to reselect a selected node when a trigger signal is input.

The evaluation selection unit 70 transmits results of selection of the selected node to the acquisition unit 80. The acquisition unit 80 is located between the physical reservoir 20 and the output unit 30.

The acquisition unit 80 is configured to connect only selected nodes among the plurality of nodes configuring the physical reservoir 20 to the output unit 30. For example, the acquisition unit 80 may be configured to connect selected nodes to the output unit 30 and disconnect unselected nodes from the output unit 30. For example, a switch may be disposed between each node of the physical reservoir 20 and the output unit 30, and the switch may be used to switch between connection and disconnection.

The connection between the selected node and the output unit 30 in the acquisition unit 80 may be configured to be switchable even after shipping, or may be fixed at the time of shipping. When the connection is fixed at the time of shipping, a selected node is set in advance.

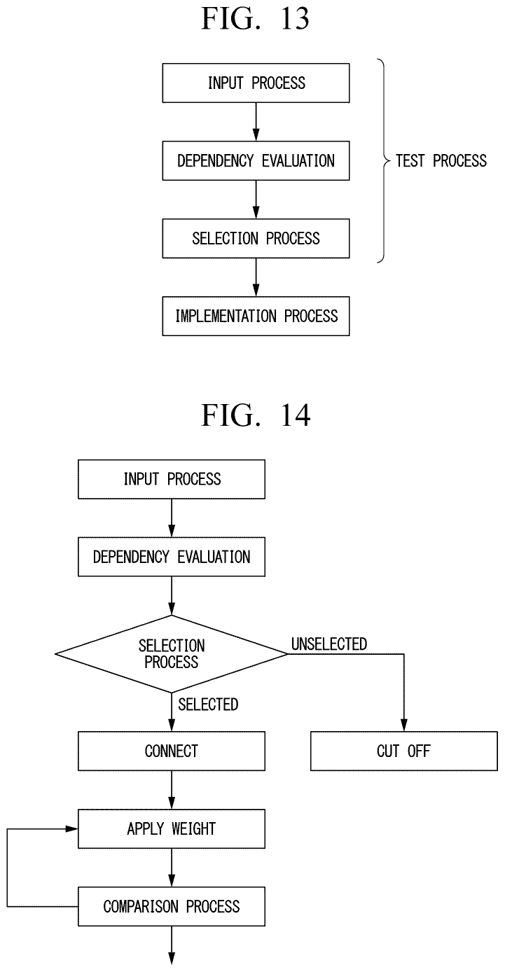

When setting a selected node in advance, the reservoir computing device 108 can be manufactured by performing a test process and an implementation process as shown in FIG. 13. The test process is performed using a sample with the same configuration as a device to be shipped. The test process may also be performed using reservoir computing using a computer.

The test process includes, for example, an input process and an evaluation selection process. In the input process, an external signal S1 is converted into a converted signal S2 and input to the reservoir. In the evaluation selection process, a first dependency is obtained between an input signal S3 input to the reservoir and an output signal S4 output from each of the plurality of nodes of the reservoir, and one or more selected nodes that exhibit a dependency that satisfies a predetermined criterion are selected from among the first dependencies. Selected nodes are determined using a test sample or simulation and then implemented on the actual shipping sample.

The implementation process includes a preparation process and a connection process. The preparation process is a process of preparing components that configure the reservoir computing device 108. The connection process is a process of connecting the components to each other. In the connection process, a node corresponding to the selected node in the test process are connected to the output unit.

The acquisition unit 80 may include, for example, a wiring unit 81 and a digital conversion unit 82. The wiring unit 81 connects a selected node to the digital conversion unit 82. An unselected node does not need to be connected to the digital conversion unit 82. The wiring unit 81 may include, for example, a multiplexer and the like. The wiring unit 81 may multiplex signals using time-division multiplexing. The digital conversion unit 82 may be configured to convert only signals from selected nodes into digital signals. The digital conversion unit 82 may be, for example, an analog-to-digital converter.

The output unit 30 performs linear conversion by applying a weight Wt to an extracted signal S7. The extracted signal S7 is a signal that is obtained by extracting only a signal output from the selected node among the output signals S4. The weight Wt is updated through learning. For example, the weight Wt may be set before a selected node is selected, or may be updated by re-learning after the selected node is selected. Re-learning after the selected node is selected improves the estimation accuracy of the reservoir computing device 108.

FIG. 14 is a flowchart of computation processing of the reservoir computing device 108. A computation processing method of the reservoir computing device 108 includes an input process, an evaluation selection process, and a learning and inference process.

In the input process, the external signal S1 is converted into the converted signal S2 and input to the physical reservoir 20.

The evaluation selection process includes a dependency evaluation process and a selection process. In the dependency evaluation process, a first dependency is obtained between the input signal S3 input to the physical reservoir 20 and the output signal S4 output from each of the plurality of nodes of the physical reservoir 20. In the selection process, a selected node is selected using an index indicating whether the first dependency satisfies a predetermined criterion. An unselected node that has not been selected is disconnected from the output unit 30.

In the learning and inference process, a weight is applied to the extracted signal S7 from the selected node selected in the selection process. When the weight Wt of the output unit 30 is calculated at once by batch learning, the weight Wt of the output unit 30 can be obtained by performing calculation such as inverse matrix calculation and regularization processing based on the extracted signal S7 from the selected nodes and the teacher signal S6. When the weight Wt is obtained sequentially by online learning, the external output signal S5 is compared with the teacher signal S6, and the weight applied to the extracted signal S7 is updated. During inference, the external output signal S5 is output as an inference result.

Regarding the teacher signal S6, a time series of a teacher signal having the same length as an input signal is typically prepared in a regression task. In a classification task and the like, only one or a smaller number of labels may be assigned to the time series of the input signal. In such a case, a sequence signal obtained by assigning a corresponding label to each time step of the input signal may be created as a teacher signal. By using a CTC loss function which is used in voice recognition and the like, a teacher signal sequence having a different length from the time series of the input signal may be used for learning.

The reservoir computing device 108 according to the ninth embodiment achieves the same effects as the reservoir computing device 100 according to the first embodiment. The reservoir computing device 108 can reduce the number of nodes that contribute to the actual computation in the physical reservoir 20 by using the evaluation selection unit 70 and the acquisition unit 80. Since the reservoir computing device 108 has a smaller number of nodes that actually contribute to computation, the reservoir computing device 108 consumes less power and requires less time for computation than when all nodes are used.

### Tenth Embodiment

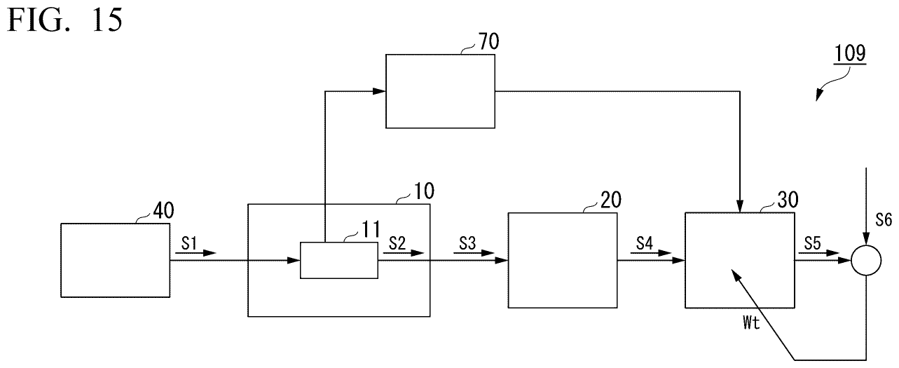

FIG. 15 is a schematic diagram of a reservoir computing device 109 according to a tenth embodiment. The reservoir computing device 108 includes, for example, an input unit 10, a physical reservoir 20, an output unit 30, a sensor element 40, and an evaluation selection unit 70. The same components as those in the above-mentioned embodiments are given the same reference numerals, and the description thereof will be omitted.

The reservoir computing device 109 according to the tenth embodiment differs from the reservoir computing device 108 according to the ninth embodiment in that it does not include an acquisition unit 80. While the reservoir computing device 108 according to the ninth embodiment extracts only signals from selected nodes using the acquisition unit 80, the reservoir computing device 109 performs this processing using the output unit 30.

The output unit 30 performs linear conversion by applying a weight Wt to an output signal S4. The output unit 30 is configured to be able to apply a zero weight to the output signal S4 from an unselected node other than a selected node. Applying zero to the output signal S4 from an unselected node is equivalent to extracting only signals from selected nodes.

The reservoir computing device 109 according to the tenth embodiment achieves the same effects as the reservoir computing device 100 according to the first embodiment. The reservoir computing device 109 can reduce the number of nodes that actually contribute to computation in the physical reservoir 20 by using the evaluation selection unit 70. Since the reservoir computing device 109 has a smaller number of nodes that actually contribute to computation, the reservoir computing device 109 consumes less power and requires less time for computation than when all nodes are used.

In the tenth embodiment, an example in which the output unit 30 extracts a signal from a selected node is described, but this processing may also be performed by the physical reservoir 20. For example, when the physical reservoir 20 is configured with an electronic circuit, an unselected node that will not be selected may be grounded to a reference potential or set to be in a high impedance state. For example, when a coupler is provided at the node of the physical reservoir 20 and a configuration in which a node state can be acquired while maintaining electrical isolation is adopted, the influence on a dynamical system will be reduced. In this case, an element such as a photocoupler or an isolator may be connected to the node of the physical reservoir 20. For example, when each node of the physical reservoir 20 is a magnetic device and its magnetic state is the state of each node, the magnetic state can also be extracted by a magnetic sensor while similarly maintaining magnetic isolation.

The embodiments of the present disclosure have been described in detail with reference to the drawings. However, the configurations and combinations thereof in the embodiments are merely examples, and addition, omission, substitution, and other modifications of the configurations can be made within the scope of the gist of the present disclosure.

For example, the characteristic configurations of the embodiments may be combined. For example, the evaluation unit 50 may be applied to a reservoir computing device according to another embodiment, the junction unit 13 may be applied to a reservoir computing device according to another embodiment, and the analysis unit 14 may be applied to a reservoir computing device according to another embodiment. The evaluation selection unit 70 and the acquisition unit 80 may also be applied to reservoir computing devices according to other embodiments.

### EXAMPLES

### Example 1

In Example 1, a reservoir computing device that distinguishes six types of motions from acceleration signals of three axes, that is, an x-axis, a y-axis, and a z-axis, is modeled and verified by simulation. The configuration of the inertial sensor in Example 1 is the same as that of the reservoir computing device 103 shown in FIG. 7.

Sensor elements can measure an x-axis acceleration, a y-axis acceleration, and a z-axis acceleration, respectively. The x-axis acceleration was assigned to a first sensor element, the y-axis acceleration was assigned to a second sensor element, and the z-axis acceleration was assigned to a third sensor element.

External signals S1 measured by the first, second, and third sensor elements were converted to create converted signals S2. The calculation in the conversion unit for obtaining the converted signals S2 was a calculation process represented by y=ax². Then, in the junction unit 13, these converted signals S2 were added up, and the square root was obtained and used as an input signal S3.

The input signal S3 and the converted signal S2 have a relationship S3={a(S2₁)²+b(S2₂)²+c(S2₃)²}^{1/2}. Here, S2₁ is a converted signal based on an external signal measured by the first sensor element, S2₂ is a converted signal based on an external signal measured by the second sensor element, S2₃ is a converted signal based on an external signal measured by the third sensor element, and a, b, and c are constants. In Example 1, a, b, and c were set to 1. In Example 1, an L2 norm of the external signal from each sensor element was calculated. By obtaining the L2 norm, a three-dimensional signal was converted into one dimension.

Next, this input signal S3 was input to the physical reservoir 20, and an output signal S4 and an external output signal S5 were obtained.

### Example 2

In Example 2, calculation in a conversion unit for obtaining converted signals S2 was a calculation process represented by y=aexp(b|x|). In the junction unit 13, these converted signals S2 were added up and used as an input signal S3.

The input signal S3 and the converted signal S2 have a relationship of S3={exp(S2₁)+exp(S2₂)+exp(S2₃)}. In Example 2, an output signal S4 and an external output signal S5 were obtained in the same manner as in Example 1.

### Comparative Example 1

Comparative Example 1 differs from Example 1 in that an external signal was directly input to a physical reservoir without performing a conversion process in an input unit. In Comparative Example 1, a three-dimensional signal was input to the physical reservoir as it is. In Comparative Example 1, an output signal S4 and an external output signal S5 were obtained in the same manner as in Example 1.

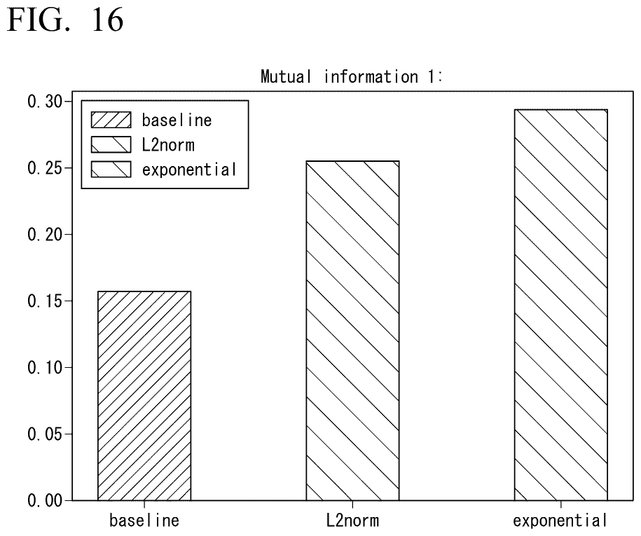

FIG. 16 shows a linearity correlation between an output signal and a teacher signal in each of a first example, a second example, and a first comparative example. “baseline” in FIG. 16 corresponds to the first comparative example, “L2 norm” corresponds to the first example, and “exponential” corresponds to the second example. The vertical axis in FIG. 16 represents a mutual information between the output signal and the teacher signal.

As shown in FIG. 16, in the first and second examples, a mutual information between the output signal and the teacher signal is larger than that in the first comparative example. That is, it can be said that, in the first and second examples, an appropriate conversion process is performed in the input unit.

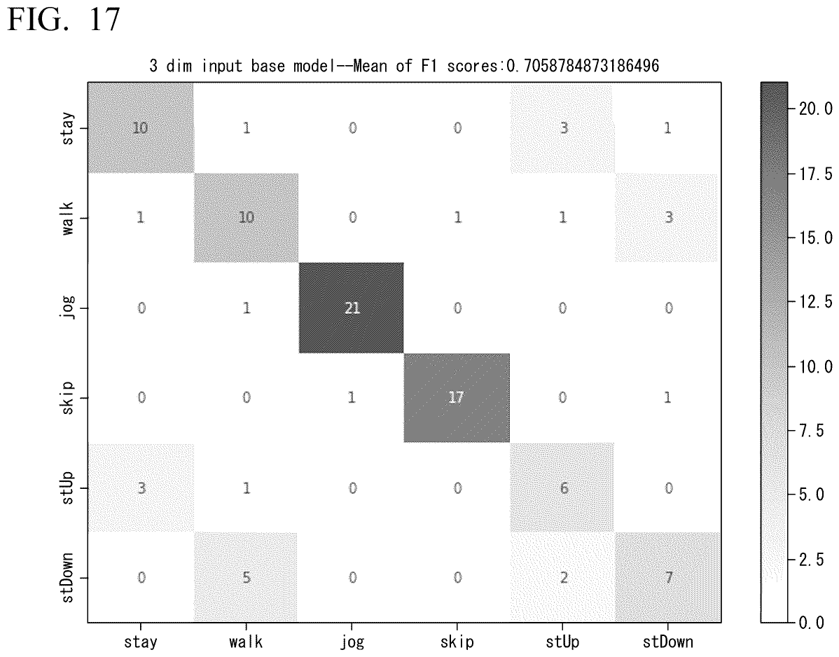

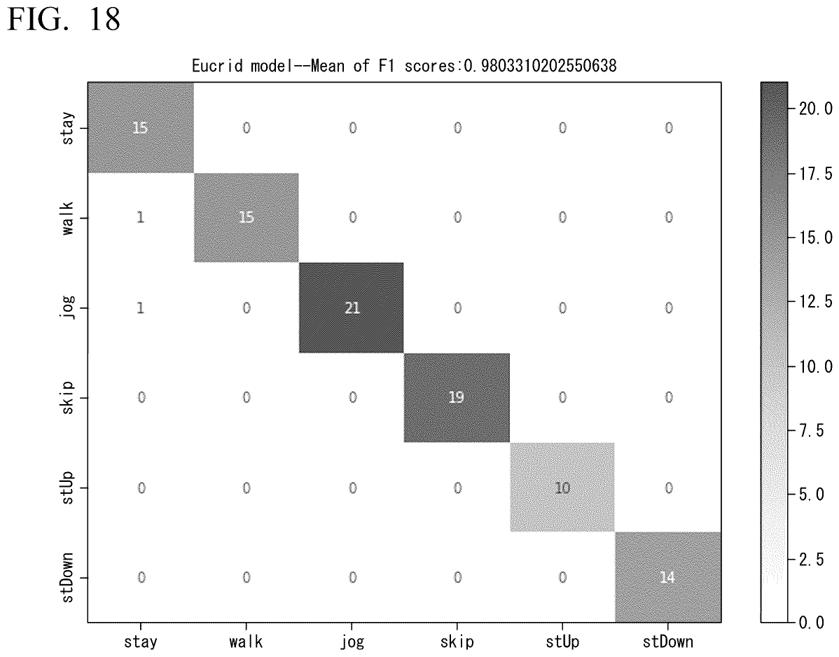

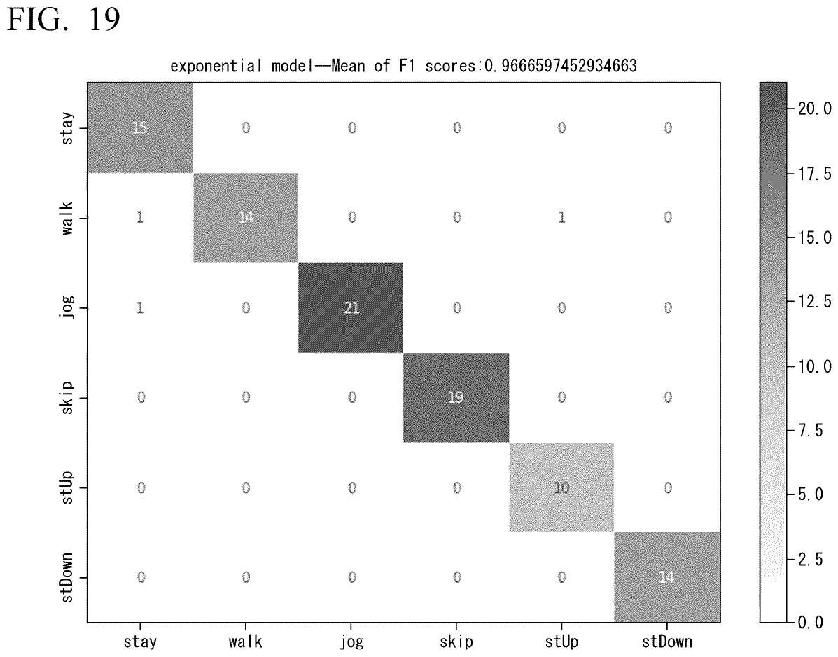

FIG. 17 shows inference results of a reservoir computing device according to the first comparative example. FIG. 18 shows inference results of a reservoir computing device according to the first example. FIG. 19 shows inference results of a reservoir computing device according to the second example.

In FIGS. 17 to 19, the vertical axis represents an estimated label obtained by the reservoir computing device, and the horizontal axis represents the teacher label. The reservoir computing device can select which of six types of actions a person is performing, on the basis of a sensor signal. Here, the actions are classified into six actions: sitting, standing, skipping, jogging, walking, and staying. When the estimated label on the vertical axis matches the teacher label (correct answer) on the horizontal axis, an estimated label is appropriately obtained.

Comparing FIG. 17, FIG. 18, and FIG. 19 with each other, it can be understood that the accuracy in the first and second examples is higher than that in the first comparative example. An F1 score in the first example was 0.980, an F1 score in the second example was 0.967, and an F1 score in the first comparative example was 0.706. The F1 score corresponds to a correct answer rate.

### Example 3

In Example 3, a trajectory prediction task of a double pendulum was verified in simulation using a modeled reservoir computing device. The task performed one-step-ahead prediction on time-series information of an X coordinate of the double pendulum, and the number of nodes in the reservoir computing device was 300. In Example 3, the time-series information of the X coordinate of the double pendulum was given as an external signal S1, and time-series information of an X coordinate one time step ahead was given as a teacher signal thereof. In the present example, delay embedding in which an embedding dimension was set to 3 and the number of delay steps was set to three was adopted as a conversion method. For example, when the time-series information of the X coordinate of the double pendulum as the external signal S1 is set to be X(t), a converted signal S2 at t=6 is [X(t=6), X(t=3), X(t=0)], and a converted signal at t=7 is [X(t=7), X(t=4), X(t=1)].

### Comparative Example 2

Comparative Example 2 differs from Example 4 in that the external signal S1 was input as it is and not converted to the converted signal S2. The other conditions were the same as in Example 4.

### Example 4

Example 4 differs from Example 3 in that, similar to the reservoir computing device 108 according to the ninth embodiment, some of the nodes of the reservoir were selected as selected nodes, and estimation processing was performed using only the selected nodes. The other conditions were the same as in Example 3. In Example 4, a dependency between the converted signal S2 and the output signal S4 was evaluated using a weight norm according to CCA as an evaluation index for a selected node selection method. In Example 4, the selected nodes were extracted in accordance with a criterion for selecting nodes in order up to a K-th node (where K is an arbitrary integer) from a node with the highest first dependency.

### Example 5

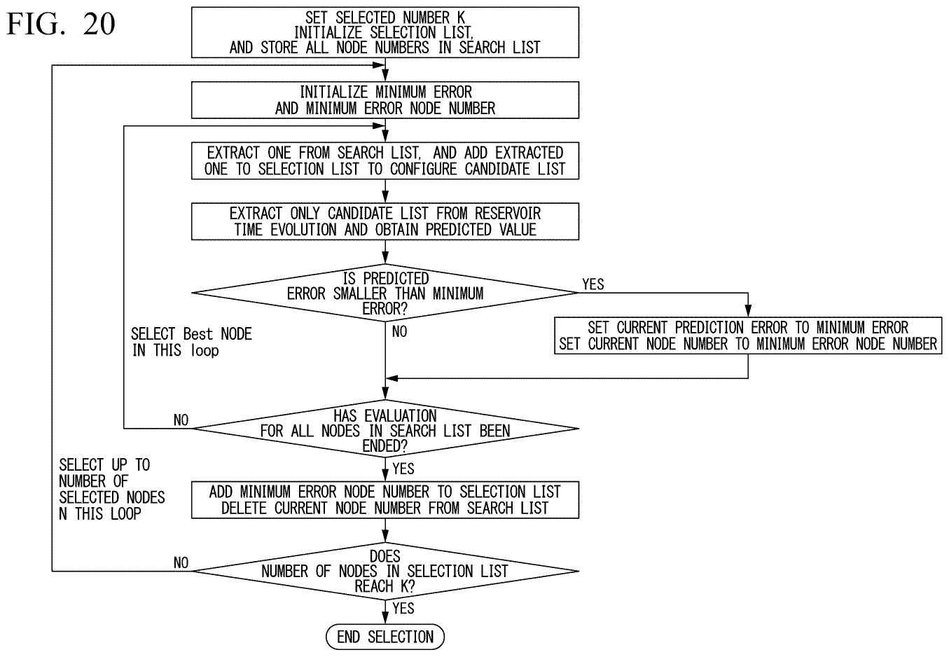

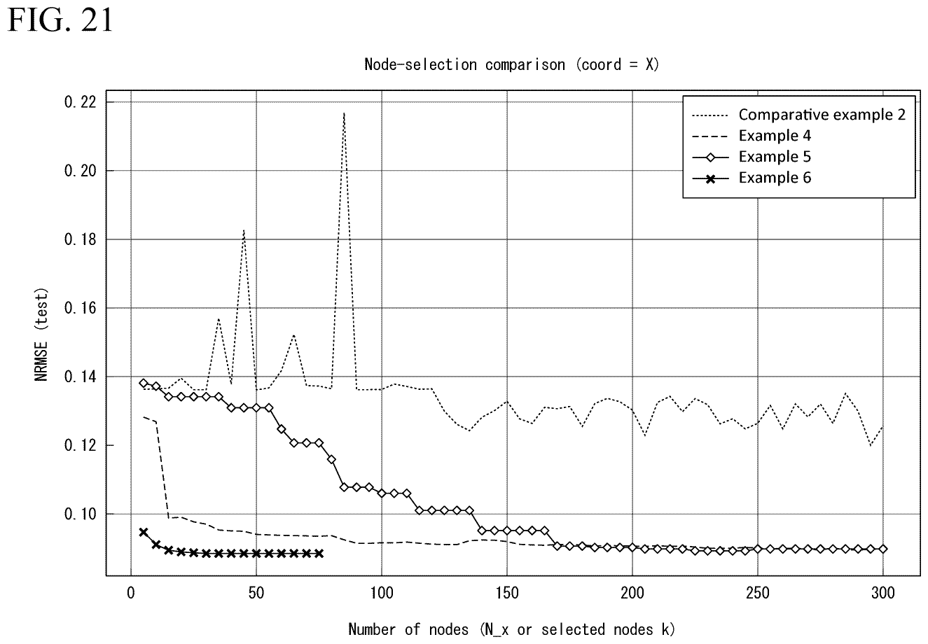

Example 5 differs from Example 3 in that, like the reservoir computing device 108 according to the ninth embodiment, some of the nodes of the reservoir are selected as selected nodes, and estimation processing is performed using only the selected nodes. The other conditions were the same as in Example 4. In Example 5, a Greedy Algorithm was used as a selected node selection method. FIG. 20 is a flowchart when selecting selected nodes in Example 5. In Example 5, the selected nodes were extracted in accordance with a criterion for selecting nodes in order up to a K-th node (where K is an arbitrary integer) from a node with the highest first dependency.

FIG. 21 shows evaluation results of Examples 3 to 5 and Comparative Example 2. The horizontal axis represents the number of selected nodes, and the vertical axis represents a root mean square error between an estimation result and a teacher signal. The smaller the value on the vertical axis, the higher the estimation accuracy. As shown in FIG. 21, Examples 3 to 5, in which the external signal S1 was converted into the converted signal S2, all had higher estimation accuracy than Comparative Example 2. In Example 4, an estimated solution with the same level of accuracy as in Example 3 was obtained, even when the number of selected nodes was reduced to approximately 170. In Example 5, an estimated solution of estimation accuracy that is more excellent than in Example 3 was obtained, even when the number of selected nodes was below 50.

### REFERENCE SIGNS LIST

10, 10A, 10B, 10C Input unit
11, 12 Conversion unit
13 Junction unit
14 Analysis unit
20, 21, 22, 23 Physical reservoir
23A, 23B Reservoir unit
30 Output unit
40, 41, 42 Sensor element
50 Evaluation unit
60 Ensemble output unit
70 Evaluation selection unit
80 Acquisition unit
100, 101, 102, 103, 104, 105, 106, 107, 108, 109 Reservoir computing device
C Learner
D Teacher signal
L1 Input layer
L2 Reservoir layer
L3 Output layer
n2, n3 Node
R Reservoir
S1 External signal
S2 Converted signal
S3, Sᵢₙ Input signal
S4, Sₒᵤₜ Output signal
S5 External output signal
S6 Teacher signal

What is claimed is:

1. A reservoir computing device comprising:
an input unit;
a physical reservoir;
an evaluation selection unit; and
an output unit, wherein
the input unit includes a conversion unit that converts an external signal into a converted signal,
the physical reservoir is connected to the input unit, and includes a plurality of nodes that are configured to perform nonlinear conversion of an input signal from the input unit and each of which is able to output an output signal,
the evaluation selection unit is configured to obtain a first dependency between the input signal input to the physical reservoir and the output signal output from each of the plurality of nodes of the physical reservoir, and to be able to select one or more selected nodes that exhibit a dependency satisfying a predetermined criterion from among the first dependencies,
the output unit is configured to be able to apply a weight to an extracted signal from the selected node among the output signals, and
the conversion unit is configured to be able to convert the external signal into the converted signal so that a second dependency between the output signal and the teacher signal is higher than the second dependency between the output signal and the teacher signal when the external signal is directly input to the physical reservoir.

2. The reservoir computing device according to claim 1, further comprising an acquisition unit provided between the physical reservoir and the output unit,
wherein the acquisition unit is configured to connect only the selected node and the output unit together.

3. The reservoir computing device according to claim 2, wherein
the acquisition unit includes a wiring unit and a digital conversion unit,
the wiring unit connects each of the plurality of nodes of the physical reservoir to the digital conversion unit, and
the digital conversion unit converts only a signal from the selected node into a digital signal.

4. The reservoir computing device according to claim 1, wherein the first dependency is obtained using any one of a mutual information amount between each of the output signals and the converted signal, a maximum cross-correlation between each of the output signals and the converted signal, a canonical correlation coefficient based on canonical correlation analysis (CCA), or a coefficient of determination indicating an error between a predicted value output by the reservoir computing device and a teacher signal.

5. The reservoir computing device according to claim 1, wherein the predetermined criterion is a criterion for determining whether the first dependency exceeds a threshold value, or a criterion for selecting nodes in order up to a K-th node (where K is an arbitrary integer) from a node with the highest first dependency.

6. The reservoir computing device according to claim 1, wherein the evaluation selection unit selects the selected node using a Greedy Algorithm.

7. The reservoir computing device according to claim 1, wherein the output unit is configured to be able to apply a zero weight to output signals from unselected nodes other than the selected nodes.

8. The reservoir computing device according to claim 1, wherein the evaluation selection unit is configured to be able to disconnect unselected nodes other than the selected nodes from the output unit.

9. The reservoir computing device according to claim 1, wherein the evaluation selection unit grounds unselected nodes other than the selected nodes.

10. The reservoir computing device according to claim 1, wherein the evaluation selection unit reselects the selected node in accordance with a predetermined rule.

11. The reservoir computing device according to claim 1, wherein the conversion unit uses any one of delay embedding, a filter bank, non-linear conversion, or a small-scale learner.

12. The reservoir computing device according to claim 1, wherein after selecting the selected node, re-learning is performed to be able to update the weight applied to the extracted signal from the selected node.

13. A method for processing a reservoir computing device, comprising:
an input process of converting an external signal into a converted signal and inputting it into a physical reservoir;
an evaluation selection process of obtaining a first dependency between an input signal input to the physical reservoir and an output signal output from each of a plurality of nodes of the physical reservoir, and selecting one or more selected nodes that exhibit a dependency satisfying a predetermined criterion from among the first dependencies; and
a learning and inference process of applying a weight to extracted signals from the selected nodes selected in the evaluation selection process,
wherein the converted signal is set such that a second dependency between the output signal and a teacher signal is higher than a second dependency between the output signal and the teacher signal when the external signal is directly input to the physical reservoir.

14. A method for manufacturing a reservoir computing device, comprising:
a test process using a reservoir computing unit; and
an implementation process of implementing results of the test process, wherein
the test process includes an input process of converting an external signal into a converted signal and inputting it to a reservoir, and
an evaluation selection process of obtaining a first dependency between an input signal input to the reservoir and an output signal output from each of a plurality of nodes of the reservoir, and selecting one or more selected nodes that exhibit a dependency satisfying a predetermined criterion from among the first dependencies,
the converted signal is set such that a second dependency between the output signal and a teacher signal is higher than a second dependency between the output signal and the teacher signal when the external signal is directly input to the reservoir, and
the implementation process includes
a preparation process of preparing an input unit, a physical reservoir, and an output unit, and
a connection process of connecting the input unit to the physical reservoir and connecting the output unit only to nodes corresponding to the selected nodes in the test process.
